(19) United States
(12) Patent Application Publication
(10) Pub. No.: US 2025/0050148 A1
(43) Pub. Date: Feb. 13, 2025

(54) REMOTE TRIGGERING OF A FIRE EXTINGUISHING OPERATION IN A FIRE ZONE OF A PROPULSION SYSTEM

(71) Applicant: Safran Nacelles, GONFREVILLE-L'ORCHER (FR)

(72) Inventors: Patrick GONIDEC, MOISSY-CRAMAYEL (FR); Patrick André BOILEAU, MOISSY-CRAMAYEL (FR)

(73) Assignee: Safran Nacelles, GONFREVILLE-L'ORCHER (FR)

(21) Appl. No.: 18/723,071

(22) PCT Filed: Dec. 21, 2022
(86) PCT No.: PCT/FR2022/052460

§ 371 Date: Jun. 21, 2024

(30) Foreign Application Priority Data
Dec. 22, 2021 (FR) FR2114237

(51) Int. Cl. A62C 3/08; A62C 37/36; B64D 45/00

(52) U.S. Cl. CPC A62C 3/08; A62C 37/04; B64D 45/00; B64D 2045/009

(57) ABSTRACT

An assembly for an aircraft propulsion system including a nacelle extending around a longitudinal axis and including an internal face that delimits, with an external face of the aircraft propulsion system, a fire zone, an extinguisher for extinguishing a fire in the fire zone, the extinguisher including a tank for containing an extinguishing agent, and a spraying nozzle for spraying the extinguishing agent out of the tank and into the fire zone, an activation device for activating the extinguisher, and a controller that transmits a control order to the activation device, the activation device receiving the control order and transmitting an activation order to the extinguisher, the activation order activating the extinguisher so as to cause the expulsion of the extinguishing agent via the nozzle. The extinguisher is mounted on the nacelle. The assembly includes one or more of a wireless communicator and a cable.

### FIELD OF THE INVENTION

This invention relates to an assembly for an aircraft propulsion system, comprising a nacelle and an extinguisher mounted on the nacelle, as well as an aircraft comprising such an assembly. This invention also relates to a method for activating an extinguisher suitable for being implemented by means of such an assembly.

### PRIOR ART

An aircraft conventionally comprises at least one propulsion system to ensure its propulsion. The propulsion system comprises a turbomachine, for example a turbojet engine or a turboprop engine, or can be a hybrid or electric engine.

The turbomachine comprises a fan, at least one compressor, a combustion chamber, at least one turbine, and a gas exhaust nozzle. For example, the turbomachine may comprise a low-pressure compressor and a high-pressure compressor, and a high-pressure turbine and a low-pressure turbine.

A turbojet engine may be a bypass turbojet engine, in which the mass of air taken in by the fan is divided into a primary flow, which traverses the at least one compressor, the combustion chamber and the at least one turbine, and a secondary flow, which is concentric with the primary flow.

The turbomachine is housed in a nacelle. The nacelle is attached to a pylon, or mast, which supports the propulsion system, the pylon being itself attached under a wing of the aircraft.

As illustrated in FIGS. 1a and 1b, a nacelle 1 may comprise an air intake upstream of the turbomachine 2, the upstream and the downstream being defined with respect to the direction of flow of the gas in the turbomachine 2 in operation, a fan casing 15 surrounding the fan of the turbomachine 2, an intermediate casing at least partially surrounding a compressor of the turbomachine 2, and an Internal Fixed Structure (IFS) 11. The internal fixed structure 11 surrounds at least the combustion chamber of the turbomachine 2. The expulsion nozzle 23 of the turbomachine is located downstream of the internal fixed structure 11.

A fire zone of the propulsion system is a zone in which it is necessary to be able to extinguish any fire that might break out there. A fire zone is thus defined by the possible presence of a flammable fluid (oil, kerosene, hydraulic oil etc.) simultaneously with an ignition source (electrical circuit, hot parts, source of sparks . . . ).

The internal fixed structure of the nacelle and the combustion chamber of the turbomachine can delimit a so-called “hot” fire zone. This hot fire zone is subjected to high temperatures during the operation of the turbomachine, typically greater than 110° C., for example in the environs of 250° C. or even 500° C., including when there is no fire in the turbomachine.

The fan casing 15 of the nacelle and the fan delimit a so-called “cool” fire zone. When the turbomachine is in operation this cool fire zone is subjected, when there is no fire, to temperatures lower than those of the hot fire zone.

In order to avoid damaging vital structures of the aircraft when a propulsion system catches fire, current regulations require the presence of an extinguishing device which is able to extinguish a fire breaking out in any of the fire zones of the propulsion system.

Current extinguishing devices are conventionally mounted under the aircraft wing, in proximity to the pylon on which the propulsion system is mounted, or directly under the pylon, so as to be carried by the pylon or by the wing. These extinguishing devices may consist of spherical bottles of pressurized gas, which resist the internal pressure by limiting the mass of the bottle: for example, they can be cylinders distributed under the pylon and containing Halon, which is a gaseous agent based on bromotrifluoromethane. FIG. 2 illustrates such an extinguishing device comprising spherical bottles 3′ of pressurized gas mounted under the wing 500 of the aircraft, near the pylon 600.

These extinguishing devices further comprise a control unit, mounted on the pylon or on the wing in proximity to the spherical bottles of pressurized gas, and connected to them by an electrical cable. The pilot, informed of the fire when the fire sensors detect a fire in the propulsion system, can trigger an extinguishing operation by sending a command from the cockpit to the control unit. The command is transmitted from the control unit to the spherical bottles of pressurized gas via the electrical cable. In response to the command, the spherical bottles of pressurized gas spray the fire zone concerned by the fire.

However, the extinguishing agent is injected via the upper part of the nacelle, at a position that can be relatively far away from the fire to be extinguished. Thus, a large quantity of extinguishing agent must be injected to be able to submerge the fire zone for the purpose of extinguishing the fire, which gives rise to considerable losses of extinguishing agent. This leads to a significant increase in the weight of the extinguishing device, and therefore of the propulsion system. Ducts can be put in place to convey the extinguishing agent from the cylinders to the fire zones in order to inject the extinguishing agent as close as possible to the fire. However, these ducts are complex, heavy, and if one wishes to inject as close as possible to the nacelle, the extension of these lines requires additional connections during the disassembly and reassembly of the nacelle for reasons of maintenance of the turbomachine, which gives rise to complications and safety risks if incorrect connections have been made. Furthermore, the cylinders, incorporated under the wing or under the pylon, degrade the aerodynamics of the flow at the level of the pylon, which decreases the propulsive efficiency of the turbomachine.

Finally, Halon is a gas with a very high greenhouse effect, and therefore very polluting. It therefore tends to be replaced by other less polluting extinguishing agents, such as NOVEC 1230, also known as FK-5-1-12, which is a liquid agent that becomes gaseous on leaving a spraying nozzle.

Known extinguishing devices are suitable for injecting a liquid extinguishing agent other than Halon via a pressurized syringe. For example, the document FR 3,077,989 A1 describes an extinguishing device comprising a storage tank of an extinguishing agent, a variable volume chamber, a piston located between the tank and the variable volume chamber, and a gas generator configured to pressurize the extinguishing agent in order to distribute it outside the tank. To be activated and thus trigger an extinguishing operation, these devices require an activation energy in the order of a few Watts. This activation energy makes it possible to trigger the ignition of the gas generator. The gas generator then injects a propellant gas into the variable volume chamber, which causes a displacement of the piston which tends to expel the extinguishing agent out of the tank via the nozzle. The activation energy is supplied to the gas generator from the control unit via an electrical cable connecting the control unit to the gas generator.

Other extinguishing devices, such as that described in the document FR 3,060,652 A1, make provision for smothering the fire in fire zones of a nacelle by choking, using a suitable gas to move a flexible extinguishing wall toward the fire zone of the nacelle, in order to dispense with chemical extinguishing agents.

Finally, the document FR 3,041,936 A1 describes an extinguishing device comprising a tank of extinguishing agent located at the level of the upstream section or of the median section of the nacelle. The extinguishing agent can be released by the explosion of a pyrotechnic cartridge, which generates pressurized gas. However, the extinguishing device is then located far from the so-called “hot” fire zone of the nacelle, and the extinguishers are not configured to inject the extinguishing agent into it. Consequently, this extinguishing device does not make it possible to effectively extinguish a fire breaking out in this hot fire zone. Extinguishing a fire in the hot fire zone would presuppose the addition of complex ducts to connect the extinguisher to the internal fixed structure of the nacelle. Furthermore, the extinguishing device itself could not be moved to the level of the internal fixed structure of the nacelle, since it has a limited resistance to high temperatures, and would not withstand the temperatures to which the hot fire zone of the nacelle is exposed.

Finally, the extinguisher is then mounted on the nacelle, and thus at a distance from the control unit, which is mounted on the pylon. The electrical cable that transmits the activation order from the control unit to the extinguisher connects the control unit mounted on the pylon to the extinguisher mounted on the nacelle. Consequently, this extinguishing device complicates maintenance when the propulsion system and/or the nacelle have to be dismounted. Specifically, the control unit mounted on the pylon is not affected by the dismounting of the propulsion system. On the other hand, since the extinguisher is mounted on the nacelle, it has to be dismounted with the nacelle or the propulsion system. Consequently, the electrical cable connecting the control unit and the extinguisher has to be unplugged during the dismounting of the propulsion system or of a component of the propulsion system on which the extinguisher is mounted, then plugged in again at the time of remounting, after the maintenance operation. However, a cable that is unplugged or has been incorrectly plugged in again would pose considerable safety problems, since it could render take-off impossible or give rise to accidents by preventing the triggering of an extinguishing operation. This extinguishing device therefore adds to the complexity of the maintenance operation, in that it requires a step of unplugging the cable, a step of plugging in the cable, and a step of checking that the cable has been correctly plugged in after the maintenance operation. Moreover, this extinguishing device incurs risks to passenger safety.

### SUMMARY OF THE INVENTION

One subject of this invention is to make provision for an assembly suitable for performing an extinguishing operation in a fire zone of a turbomachine, that does not complicate maintenance operations on the propulsion system and does not impair the safety of the extinguishing operation.

Another subject of this invention is to make provision for an assembly making it possible to remotely trigger an extinguishing operation.

According to a first aspect, the invention relates to an assembly for an aircraft propulsion system, comprising:
a nacelle extending around a longitudinal axis and suitable for being disposed around the propulsion system, said nacelle comprising an internal face suitable for delimiting, with an external face of the propulsion system, a fire zone;
an extinguisher designed to extinguish a fire in the fire zone, the extinguisher comprising a tank suitable for containing an extinguishing agent, and a spraying nozzle configured to spray the extinguishing agent out of the tank and into the fire zone;
an activation device for activating the extinguisher;
a control unit suitable for transmitting a control order to the activation device, the activation device being suitable for receiving the control order transmitted by the control unit and for transmitting an activation order to the extinguisher in response to the receiving of the control order, said activation order being suitable for activating the extinguisher so as to cause the expulsion of the extinguishing agent via the nozzle,
   the assembly being characterized in that the extinguisher is mounted on the nacelle, and in that it further comprises at least one of the following elements for transmitting the control order from the control unit to the activation device:
a wireless communication means between the control unit and the activation device;
a cable connecting the control unit and the activation device, and a system for detecting an unplugged state of said cable.

Certain preferred but non-limiting features of the assembly described above are as follows, taken individually or in combination:
the wireless communication means between the control unit and the activation device comprises at least one of the following elements: a means of communication by radio signal, for example of Wi-Fi Wireless Avionics Intra-Communications, and/or RFID type; a means of communication by light signal, for example of laser, Visible light communication, Li-Fi, and/or optoelectronic system type; a means of communication by wave, for example of microwave type, said wave being suitable for being transmitted to the structure of the nacelle;
the element for transmitting the control order is a wireless communication means and is moreover configured to determine whether or not the control unit and the activation device are within communication range;
the extinguisher further comprises a variable volume chamber, a piston located between the tank and the variable volume chamber, and a gas generator configured to inject a propellant gas into the variable volume chamber, said injection of propellant gas being suitable for giving rise to a movement of the piston to pressurize the extinguishing agent;
the transmitting element comprises a cable, the activation device comprises the gas generator, and the cable connects the control unit and the gas generator of the extinguisher;
the assembly comprises several extinguishers, the activation device being suitable for selectively activating one or more of the extinguishers of the assembly, for example by way of: elements for transmitting the activation order that differ according to the extinguishers, frequencies of transmission of the activation order that differ according to the extinguishers, and/or identifiers that differ according to the extinguishers;
the activation order transmitted by the activation device to the extinguisher comprises a wave having an energy greater than or equal to an activation energy of the extinguisher;
the activation order transmitted by the activation device to the extinguisher comprises a wave having an energy strictly less than an activation energy of the extinguisher, and the activation device further comprises a local energy source suitable for activating the extinguisher in response to the receiving of the activation order;
the assembly further comprises a pylon, the nacelle being attached to the pylon.

According to a second aspect, the invention relates to an aircraft comprising an assembly according to the first aspect, a propulsion system, a wing, and a pylon attached under the wing of the aircraft, the nacelle being attached to the pylon.

Optionally, the control unit is mounted on the pylon.

According to a third aspect, the invention relates to a method for activating an extinguisher suitable for being implemented by means of an assembly according to the first aspect, said method comprising the following steps:
transmitting a control order by the control unit to the activation device of the extinguisher, said transmission being done by means of a wireless transmission and/or by means of a transmission by cable connecting the control unit and the activation device, the method then further comprising a step of detecting an unplugged state of said cable;
receiving the control order by the activation device;
transmitting an activation order by the activation device to the extinguisher, in response to the receiving of the control order; and
expelling the extinguishing agent via the nozzle in response to the receiving of the activation order by the extinguisher.

### DESCRIPTION OF THE FIGURES

Other features, aims and advantages of this invention will become apparent on reading the following detailed description, given by way of non-limiting example, which will be illustrated by the following figures:

FIG. 1a, already commented on, is an exploded view of a nacelle and of a propulsion system of an aircraft of the prior art.

FIG. 1b, already commented on, is a side view of a nacelle and of a propulsion system of an aircraft of the prior art.

FIG. 2, already commented on, is a wire frame view of an extinguishing assembly for an aircraft of the prior art.

FIG. 3 is a schematic side view of an assembly according to an embodiment of the invention comprising two pairs of two extinguishers suitable for being activated by optical fibers, and of a propulsion system.

FIG. 4 is a schematic side view of an assembly according to an embodiment of the invention comprising two pairs of two extinguishers suitable for being activated by wireless communication, and of a propulsion system.

FIG. 5 is a schematic side view of an extinguisher of an assembly according to an embodiment of the invention, suitable for being activated by a local energy source.

FIG. 6 is a schematic side view of an extinguisher of an assembly according to an embodiment of the invention, suitable for being activated by an energy source of the airplane.

FIG. 7 is a schematic side view of an extinguisher of an assembly according to an embodiment of the invention, mounted on an internal face of an internal fixed structure of the nacelle.

### DETAILED DESCRIPTION OF THE INVENTION

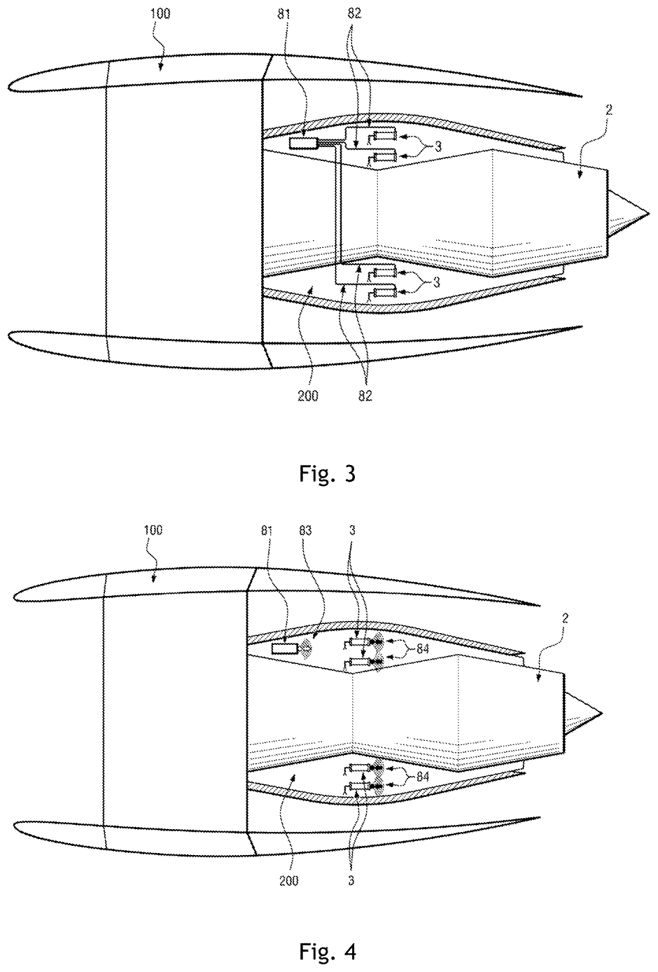

An assembly for an aircraft propulsion system 2 is illustrated by way of non-limiting example in FIGS. 3 to 6. The assembly comprises:
a nacelle 1 extending around a longitudinal axis and suitable for being disposed around the propulsion system 2, said nacelle 1 comprising an internal face 12 suitable for delimiting, with an external face of the propulsion system 2, a fire zone 100, 200;
an extinguisher 3 designed to extinguish a fire in the fire zone 100, 200, the extinguisher 3 comprising a tank suitable for containing an extinguishing agent, and a spraying nozzle 36 configured to expel the extinguishing agent out of the tank and into the fire zone 100, 200;
an activation device 81 for activating the extinguisher 3;
a control unit suitable for transmitting a control order to the activation device 81, the activation device 81 being suitable for receiving the control order transmitted by the control unit and for transmitting an activation order to the extinguisher 3 in response to the receiving of the control order, said activation order being suitable for activating the extinguisher 3 so as to cause the expulsion of the extinguishing agent via the nozzle 36.

The assembly is characterized in that the extinguisher 3 is mounted on the nacelle 1, and in that it further comprises the at least one of the following elements for transmitting the control order from the control unit to the activation device 81:
a wireless communication means between the control unit and the activation device 81;
a cable connecting the control unit and the activation device 81, and a system for detecting an unplugged state of said cable.

The propulsion system may be a turbomachine, for example a turbojet engine or a turboprop engine, or may be a hybrid or electric engine.

In this application, the upstream and the downstream are defined with respect to the propulsion system, and in particular with respect to the normal direction of flow of the gas through the turbomachine. The longitudinal axis along which the nacelle 1 mainly extends corresponds to an axis of the propulsion system, and in particular to an axis of rotation of the turbomachine fan. A radial axis is an axis perpendicular to the longitudinal axis and passing through it. A transverse axis is an axis perpendicular to the longitudinal axis and not passing through it. A longitudinal direction, or a radial direction and transverse direction respectively, corresponds to the direction of the longitudinal axis, or the radial and transverse axis respectively.

The terms internal and external, respectively, are used with reference to a radial direction such that the internal part or face of an element is closer to the longitudinal axis than the external part or face of the same element.

When the propulsion system is a turbomachine, the turbomachine can for example be a turbojet engine or a turboprop engine.

The turbomachine comprises a fan, at least one compressor, a combustion chamber, at least one turbine, and a gas exhaust nozzle. For example, the turbomachine may comprise a low-pressure compressor and a high-pressure compressor, and a high-pressure turbine and a low-pressure turbine.

A turbojet engine can be a bypass turbojet engine, in which the mass of air taken in by the fan is divided into a primary flow which traverses the at least one compressor, the combustion chamber and the at least one turbine, and a secondary flow which is concentric with the primary flow. The primary flow circulates in a primary air path Vp and the secondary flow circulates in a secondary air path Vs.

The propulsion system 2 is housed in a nacelle 1. The fan can therefore be ducted. The nacelle 1 is attached to a pylon 600, or mast, which supports the propulsion system 2, said pylon 600 being attached under a wing 500 of the aircraft.

The nacelle 1 may comprise an air intake suitable for being disposed upstream of the turbomachine 2, a fan casing 15 suitable for surrounding the fan, an intermediate casing 16 suitable for surrounding at least one compressor of the turbomachine 2, and an Internal Fixed Structure (IFS) 11 suitable for surrounding at least the combustion chamber of the turbomachine 2. The internal fixed structure 11 can moreover surround all or part of the compressor and/or turbine stages of the turbomachine 2. The intermediate casing can be located in the immediate extension of the internal fixed structure 11. The gas exhaust nozzle 23 of the turbomachine 2 is located downstream of the internal fixed structure 11.

A fire zone 100, 200 of the propulsion system 2 is a zone in which it is necessary to be able to extinguish any fire that might break out there. A fire zone 100, 200 is thus defined by the possible presence of a flammable fluid (oil, kerosene, hydraulic oil etc.) simultaneously with an ignition source (electrical circuit, hot parts, source of sparks . . . ).

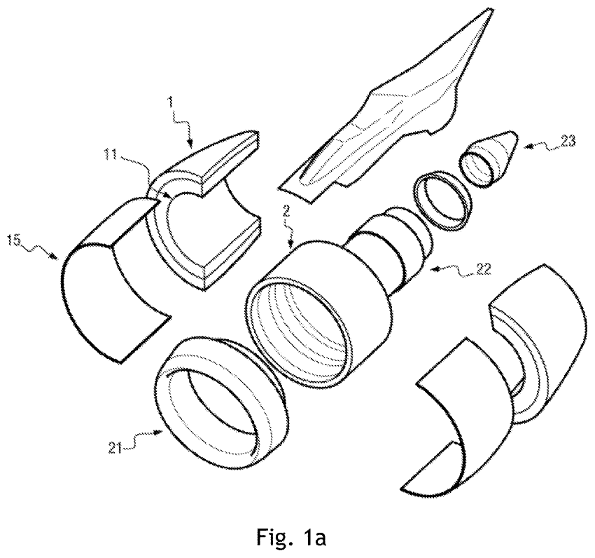

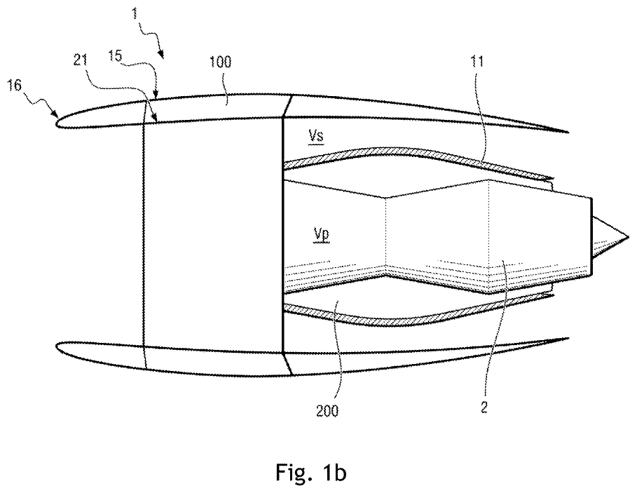

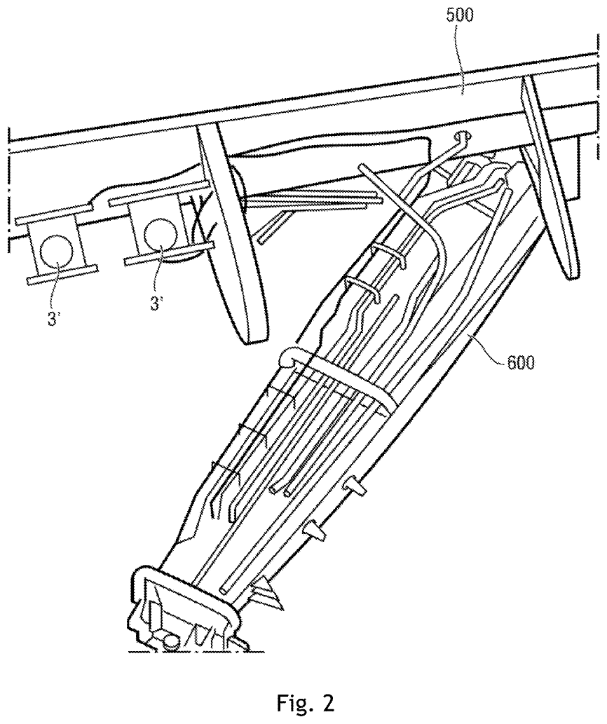

A so-called “hot” fire zone 200 of a nacelle 1 of a turbomachine is delimited by an internal face 12 of the internal fixed structure 11 and an external face of the combustion chamber of the turbomachine 2, as illustrated on FIG. 1b, already commented on. This hot fire zone 200 extends upstream all the way to the partition of the central intermediate casing of the turbomachine 2 and downstream all the way to the annular ventilation outlet composed of the rear part of the internal fixed structure 11 of the nacelle 1 and the external part of the nozzle 23. This hot fire zone 200 is subjected to high temperatures during the normal operation of the turbomachine 2, i.e. when there is no fire, typically greater than 110° C., for example in the environs of 250° C. or even 500° C.

A so-called “cool” fire zone 100 of a nacelle of a turbomachine, also illustrated on FIG. 1b already commented on, is delimited by an internal face of the fan casing 15 and/or of the intermediate casing of the nacelle 1 and an external face of the fan and/or of the compressor. The cool fire zone 100 is subjected during the normal operation of the turbomachine 2, i.e. when there is no fire, to temperatures lower than those of the hot fire zone 200.

The extinguisher 3 of the assembly described above is mounted on the nacelle 1, in particular on an internal face 12 of the nacelle 1, and is therefore carried by the nacelle 1, and not by the wing 600 or the pylon 500 as in the prior art. The extinguisher 3 can in particular be mounted inside the nacelle 1. Thus, the extinguisher 3 no longer takes up space at the level of the pylon 500, which makes it possible to optimize its position and dimensions with greater flexibility.

The extinguisher 3 is mounted on the nacelle 1, in proximity to the fire zone 100, 200, or even in the fire zone 100, 200. This makes it possible to position the nozzle 36 in the fire zone 100, 200. Thus, the extinguishing agent is expelled by the nozzle 36 directly into the fire zone 100, 200, without requiring any long, complex and heavy ducts to distribute the extinguishing agent from the tank of the extinguisher 3 to the fire zone 100, 200, and with no loss of extinguishing agent between the injection point and the fire zone 100, 200. Thus, the efficiency of the extinguishing operation is improved due to the mounting of the extinguisher 3 on the nacelle 1.

Furthermore, the assembly can make it possible to extinguish a fire in any fire zone 100, 200 of the nacelle 1 of the propulsion system can in particular be used to extinguish a fire in the cool fire zone 100 or in the hot fire zone 200 of the nacelle 1 of a turbomachine.

The control unit is mounted on an element outside the nacelle 1 and located at a distance from the nacelle 1. The control unit can for example be mounted on the pylon 500 or in the cockpit.

The activation device 81 can be mounted for example on the pylon 500, or on the nacelle 1. An activation device 81 mounted on the nacelle 1 makes it possible to not have to connect or disconnect transmitting elements between the activation device 81 and the extinguisher 3 when the nacelle 1 or the propulsion system 2 is dismounted or mounted.

In a first embodiment, the transmission of the control order and/or the activation order between the control unit and the extinguisher 3 is done by a cable, and the assembly further comprises a system for detecting un unplugged state of the cable. The cable can for example be an electrical cable, or an optical fiber cable. When the cable is in the plugged-in state, it connects the control unit and the activation device 81 of the extinguisher 3. The control unit can then communicate with the activation device 81, and in particular can transmit the control order to the activation device 81, by an electrical or light signal. When the cable is unplugged, it does not make it possible to set up the communication between the control unit and the activation device 81.

The assembly according to the first embodiment makes it possible to keep the same level of safety, limit the complication of the maintenance operation, and improve the effectiveness of the extinguishing operation, by comparison with an extinguisher 3 mounted on the pylon 500. In this case, the control unit when mounted on the pylon 500 is not affected by the dismounting of the propulsion system 2, i.e. it remains in place during the dismounting of the propulsion system 2. On the other hand, since the extinguisher 3 is mounted on the nacelle 1, it must be dismounted with the nacelle 1 or the propulsion system 2. Consequently, the cable which connects the control unit and the extinguisher 3 must be unplugged during the dismounting of the propulsion system 2 or of a component of the propulsion system 2 on which the extinguisher 3 is mounted, then plugged in again at the time of remounting, after the maintenance operation.

The checking of the correct plugging-in of the cable is done by the detection system, which automatically alerts the user when the cable is unplugged, for example that the operator has forgotten to plug it in again, or has plugged it in again incorrectly, after the maintenance operation. Consequently, the complication of the maintenance operation is limited to the fact of unplugging the cable and plugging it in again, but does not also require the checking of the correct plugging-in of the cable at the end of the maintenance operation. Furthermore, this extinguishing device makes it possible to maintain a same level of passenger safety, since the risk of incorrect plugging-in of the cable is eliminated due to the presence of the detection system. Finally, the effectiveness of the extinguishing operation is improved due to the extinguisher 3 being mounted on the nacelle 1.

In a second embodiment, the transmission of the control order and/or the activation order between the control unit and the extinguisher 3 is done by the wireless communication means. The assembly according to the second embodiment makes it possible to facilitate the maintenance of the airplane, to keep the same level of safety for the passengers and improve the effectiveness of the extinguishing operation, by comparison with an extinguisher 3 mounted on the pylon 500. Specifically, the effectiveness of the extinguishing operation is improved due to the extinguisher 3 being mounted on the nacelle 1. Furthermore, the connection between the pylon 500 and the nacelle 1 is eliminated, since the control order is transmitted remotely from the control unit, optionally mounted on the pylon 500, to the activation device 81. Consequently, in the event of a maintenance operation on the propulsion system 2 or the nacelle 1, there is no cable to be plugged in and unplugged and no safety problem related to an incorrect plugging-in of the cable arises, since there is no cable connecting the control unit and the extinguisher 3. Thus, no operation is necessary to disconnect or reconnect the control line of the extinguishing operation during the dismounting or remounting of the engine or of the nacelle 1 elements bearing this integrated extinguishing operation.

One or more, or even all, the elements of the assembly, in particular the control unit, the wireless communication means, the cable, the activation device 81, the extinguisher 3, etc., can be fireproof. For example, these elements can be fireproof due to their intrinsic design, for example their material and/or their internal design, or due to the protections of the fire environment added to these elements. Thus, the assembly remains functional even if a fire breaks out in the propulsion system 2, during and after the fire.

The nacelle 1 may comprise an external face 13 radially opposite the internal face 12. The external face 13 of the nacelle 1 may be suitable for delimiting, outside, an air flow space, such as a secondary air path Vs portion of the turbomachine 2 or an ambient air flow outside the aircraft. Thus, air, particularly fresh air, circulates in contact with and outside the external face 13 of the nacelle 1.

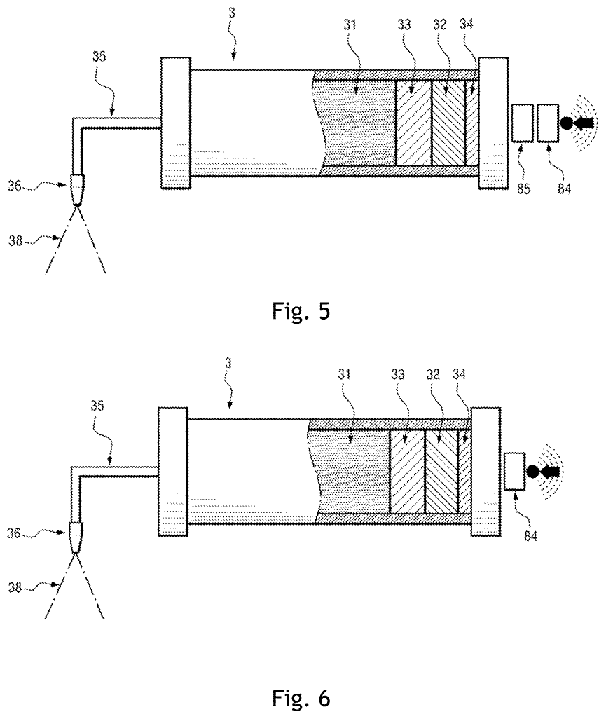

The extinguisher 3, illustrated by way of non-limiting example in FIGS. 5 to 7, may further comprise a variable volume chamber 32, a piston 33 located between the tank 31 and the variable volume chamber 32, and a gas generator 34 configured to inject a propellant gas into the variable volume chamber 32, said injection of propellant gas being suitable for giving rise to a movement of the piston 33 to pressurize the extinguishing agent.

The extinguisher 3 may comprise a substantially cylindrical body 37 delimiting the tank 31 and the variable volume chamber 32, and housing the piston 33. The body 37 of the extinguisher 3 comprises a substantially cylindrical body wall, said body wall being closed at one end by a base wall shaped like a disc. The base wall, the body wall 37 and the piston 33 together delimit the tank 31 containing the extinguishing agent.

An orifice can be formed in the base wall of the body 37 of the extinguisher 3, for example at a central position of said base wall. The orifice is connected to the spraying nozzle 36, either directly, or via a supply hose 35 of the tank 31. Thus, the extinguishing agent contained in the tank 31 is expelled out of the tank 31 via the orifice when the piston 33 pressurizes the extinguishing agent.

The piston 33 may comprise a disc-shaped body, suitable for being translationally displaced along an axis of the cylinder of the body 37 of the extinguisher 3, by a difference in pressure between the tank 31 and the variable volume chamber 32.

The gas generator 34 forms a device for propelling the extinguishing agent. The gas generator 34 can be housed in the substantially cylindrical body 37 of the tank 31, be contiguous with the variable volume chamber 32 and open directly into the variable volume chamber 32, such that the gas is directly generated in the variable volume chamber 32. The gas generator 34 can be activated, or ignited, when an extinguishing operation is desired. An activation of the extinguisher 3 can be an ignition of the gas generator 34. The ignition requires the supplying to the gas generator 34 of an activation energy, which is generally in the order of a few Watts.

The variable volume chamber 32 into which the propellant gas is injected is delimited by the substantially cylindrical body wall of the extinguisher 3, the piston 33, and a separating wall with the gas generator 34. A volume of the variable volume chamber 32 can vary between a zero volume, the piston 33 then being adjacent to the separating wall with the gas generator 34, in contact with said separating wall, and the volume of the tank 31 being at a maximum, and a volume equivalent to a volume of the tank 31, the piston 33 then being adjacent to the base wall of the body 37 of the extinguisher 3, in contact with said base wall, and the volume of the tank 31 being zero.

When the gas generator 34 is activated, it gives rise to a generation of propellant gas in the variable volume chamber 32, which leads to an increase in the volume of the variable volume chamber 32 gradually as the propellant gas is generated, by increasing the pressure in the variable volume chamber 32. The movement of the piston 33 under the pressure of the propellant gas propels the extinguishing agent out of the tank 31 and toward the spraying nozzle 36. The extinguishing agent can then travel through the supply hose 35 until it reaches the nozzle 36. The spraying nozzle 36 allows the spraying of the extinguishing agent in the fire zone 100, 200, in a spray jet 38. The spray jet 38 coming from the nozzle 36 is a jet of the extinguishing agent, and allows the vaporization and dissemination of the extinguishing agent in gas or two-phase form in the fire zone 100, 200.

The extinguishing agent can be NOVEC 1230, also known as FK-5-1-12. NOVEC is a liquid agent which is atomized at the outlet of the nozzle 36 and becomes gaseous at ambient temperature (20° C.). At low temperatures, the Air NOVEC mixture of the extinguishing flow reaching saturation leads to the formation of a mist of liquid droplets of NOVEC in the extinguishing flow saturated with NOVEC gas. Thus, the nozzle 36 can inject at low temperatures (for example at −30° C.) a NOVEC 1230 in droplet form and in gaseous form, into the fire zone 100, 200.

The extinguisher 3 can be mounted in a radially inward position with respect to the internal face 12 of the nacelle 1, i.e. directly at the level of the fire zone 100, 200. The extinguisher 3, in particular the tank 31 of the extinguisher 3, can be mounted on the nacelle 1 by way of an extinguisher support 51.

The extinguisher can be mounted for example on the internal fixed structure 11, the fan casing 15, and/or the intermediate casing of the nacelle 1 of the propulsion system 2.

In a first exemplary embodiment, the extinguisher 3 of the assembly is designed to extinguish a fire in the cool fire zone 100 of the turbomachine 2. The extinguisher 3 can then be mounted on the fan casing 15 or on the intermediate casing of the nacelle 1, or more precisely can be mounted on an internal face 12 of the fan casing 15 or of the intermediate casing of the nacelle, i.e. at the level of the fan or of a compressor of the turbomachine 2. The extinguisher 3 is thus mounted in the cool fire zone 100 that it is designed to protect from fire. The operation of the extinguisher 3 is thus optimized and in particular makes it possible to reduce the length of the supply ducts of the extinguishing agent, or even to dispense with them. Furthermore, since the extinguisher 3 is incorporated as close as possible to the starting point of the fire to be extinguished, it can extinguish the fire at its inception, which contributes to reducing the quantity of extinguishing agent to be used to extinguish a fire breaking out in the cool fire zone 100. Optionally, the assembly can further comprise a thermal protection 4 covering the internal face 12 of the fan casing 15 or of the intermediate casing at the level of the cool fire zone 100, and the extinguisher 3 can be mounted between the thermal protection 4 and the fan casing 15 or the intermediate casing of the nacelle 1, in order to benefit from the protection of the thermal protection 4.

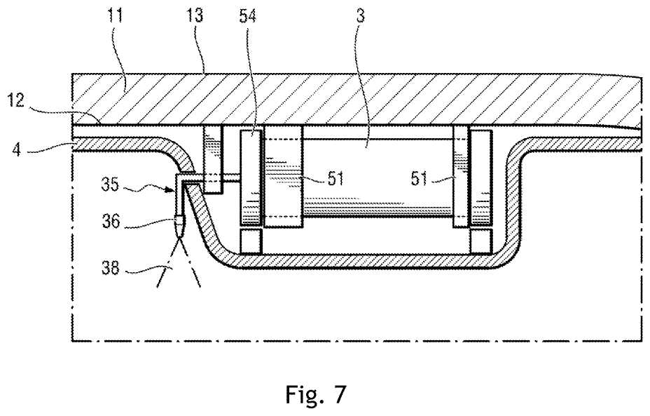

In a second exemplary embodiment, illustrated by way of non-limiting example in FIG. 7, the extinguisher 3 of the assembly is designed to extinguish a fire in the hot fire zone 200 of the turbomachine 2. The assembly then also comprises a thermal protection 4 covering the internal face 12 of the internal fixed structure 11 of the nacelle 1 at the level of the hot fire zone 200. The thermal protection 4 may be a wall consisting of a thermally insulating coating, and located at a radially more inward position than the internal face 12. The extinguisher 3, in particular the tank 31 of the extinguisher 3, can then be mounted on an internal face 12 of the internal fixed structure 11 of the nacelle 1, between the thermal protection 4 and the internal face 12 of the internal fixed structure 11 of the nacelle 1, i.e. at the level of the combustion chamber of the turbomachine 2. Thus, at the level of the extinguisher 3, the thermal protection 4 is configured to at least partially delimit an enclosure suitable for housing all or part of the extinguisher 3. The enclosure is located at the level of the hot fire zone 200 and is suitable for surrounding the extinguisher 3, so as to protect it from the high temperatures of the hot fire zone 200. The supply hose 35 or the nozzle 36 traverses the thermal protection 4, so that the extinguishing agent is expelled directly into the hot fire zone 200. The incorporation of the extinguisher 3 thus takes into account the limited resistance of the extinguisher 3 to high temperatures, and thus allows the correct operation of the extinguisher 3 if the latter is used to extinguish a fire in the hot fire zone 200, and does so without requiring any additional protection element. In addition, the extinguisher 3 is incorporated into the same hot fire zone 200 it is designed to protect from fire. The operation of the extinguisher 3 is thus optimized and in particular makes it possible to reduce the length of the supply ducts of the extinguishing agent, or even to dispense with them. Furthermore, since the extinguisher 3 is incorporated as close as possible to the starting point of the fire to be extinguished, it can extinguish the fire at its inception, which contributes to reducing the quantity of extinguishing agent to be used to extinguish a fire breaking out in the hot fire zone 200.

The first exemplary embodiment and the second exemplary embodiment are compatible, in that the assembly may comprise one or more extinguishers 3 suitable for extinguishing a fire in the cool fire zone 100 of the nacelle 1, and/or one or more extinguishers 3 suitable for extinguishing a fire in the hot fire zone 200 of the nacelle 1.

A ventilation inlet and a ventilation outlet may be formed in the internal face 12 of the nacelle 1 such that, during the operation of the propulsion system 2, a ventilation stream flows into the fire zone 100, 200 between the ventilation inlet and the ventilation outlet. This is because any fire zone 100, 200 of a propulsion system 2 must be ventilated. The nozzle 36 may be located in the fire zone 100, 200 and in the ventilation stream between the ventilation inlet and the ventilation outlet. Thus, the nozzle 36 is suitable for expelling the extinguishing agent so that the expelled extinguishing agent mixes with the ventilation stream to form a flow in the fire zone 100, 200 that makes it possible to optimize the extinguishing of the fire. Thus, the assembly uses the positioning of the nozzle 36 in the existing ventilation stream and the fact that the extinguisher 3 is mounted on the nacelle 1 to optimize the injection of extinguishing agent and thus maximize the effectiveness of the extinguisher 3 against the fire. In addition, due to the mixing of the extinguishing agent with the ventilation stream, the homogeneity of the stream of extinguishing agent in the fire zone 100, 200 is improved. Losses of extinguishing agent are thus limited.

A position and an orientation of the nozzle 36 in the fire zone 100, 200 and in the ventilation stream between the ventilation inlet and the ventilation outlet can be chosen so as to effectively model the ventilation stream via the spraying jet 38 of extinguishing agent, to optimize the stream of extinguishing agent into the fire zone 100, 200. This makes it possible to reduce the quantity of extinguishing agent needed to perform an extinguishing operation in the fire zone 100, 200.

In the first embodiment, the transmitting element comprises the cable, in particular the electrical cable, connecting the control unit and the activation device 81, and the assembly further comprises the system for detecting an unplugged state of said cable, particularly of said electrical cable.

Said detecting system can be suitable for automatically detecting an unplugged state of the cable and for automatically alerting the user in the event of an unplugged cable state being detected.

The assembly may comprise several activation devices 81, each activation device 81 being suitable for activating one or more respective extinguishers 3. Each activation device 81 is connected to the control unit by at least one cable, in particular by at least one electrical cable. The set of electrical cables connecting the activation devices 81 to the control unit forms an electrical harness.

In the second embodiment, as shown by way of non-limiting example in FIG. 4, the transmitting element comprises the wireless communication means. The control unit then comprises at least one wireless communication means suitable for transmitting the control order. The activation device 81 comprises at least one receiver suitable for receiving the control order transmitted by the control unit, and a transmitter suitable for transmitting the activation order to the extinguisher 3 in response to the receiving of the control order.

The wireless communication means may comprise any element capable of transmitting the control order from the control unit to the activation device 81. The control order can in particular comprise a wave suitable for being received by the receiver of the activation device 81, the transmitter of the activation device 81 being suitable for generating, according to the control order received, an order to activate the extinguisher 3. The receiver of the activation device 81 can be any element capable of receiving the control order transmitted by the wireless communication means.

The wireless communication means between the control unit and the activation device 81 may comprise at least one of the following elements:
a means of communication by radio signal, for example of Wi-Fi, Wireless Avionics Intra-Communications (WAIC), and/or RFID type;
a means of communication by light signal, for example of laser, Visible light communication (VLC), Li-Fi, and/or opto-electronic system type;
a means of communication by wave, for example of microwave type, said wave being a structural wave suitable for being transmitted to the structure of the nacelle 1.

The receiver of the activation device 81 may comprise at least one of the following elements:
a receiver of an electrical signal;
a receiver of a radio signal, for example of Wi-Fi, Wireless Avionics Intra-Communications (WAIC), and/or RFID type;
a receiver of a light signal, for example of optical fiber, Visible light communication (VLC), Li-Fi, photoelectric sensor, and/or optoelectronic system type;
a receiver of a structural wave, for example of microwave type, for example of piezoelectric element generator type.

In particular, when the wireless communication means between the control unit and the activation device 81 comprises a transmitter of a radio signal, of a light signal, or of a structural wave respectively, the activation device 81 may comprise a receiver of a radio signal, of a light signal, or of a structural wave respectively.

The transmitter 83 of the activation device 81 can be any element capable of transmitting the activation order intended for the extinguisher 3. The transmitter 83 of the activation device 81 may comprise at least one of the following elements for transmitting the order of activation of the activation device 81 to the extinguisher 3:
a wireless communication means between the activation device 81 and the extinguisher 3;
a cable 82 connecting the activation device 81 and the extinguisher 3, and a system for detecting an unplugged state of said cable 82.

In particular, the transmitter 83 of the activation device 81 may comprise at least one of the following elements:
a transmitter of a radio signal, for example of Wi-Fi, Wireless Avionics Intra-Communications (WAIC), and/or RFID type;
a transmitter of a light signal, for example of laser, Visible light communication (VLC), Li-Fi, photoelectric sensor, and/or optoelectronic system type;
a transmitter suitable for a proximity capacitive transmission;
a transmitter suitable for a transmission by proximity magnetic coupling;
a transmitter of a structural wave, for example of microwave type, for example of piezoelectric element generator type.

The means of communication of the activation device 81 to the extinguisher 3 may comprise at least one of the following elements:
a cable 82, such as an electrical cable or an optical fiber 82, connecting the activation device 81 to the extinguisher 3, where applicable with a connector with automatic connection and disconnection;
a means of communication by radio signal, for example of Wi-Fi, Wireless Avionics Intra-Communications (WAIC), and/or RFID type;
a means of communication by light signal, for example of Visible light communication (VLC), Li-Fi, and/or optoelectronic system type;
a means of proximity capacitive transmission;
a means of transmission by proximity magnetic coupling;
a means of communication by wave, for example of microwave type, said wave being a structural wave suitable for being transmitted to the structure of the nacelle 1.

Wireless communication means between the activation device 81 and the extinguisher 3 make it possible to limit the wiring present in the nacelle 1, in particular due to the restrictive environment in which this wiring is installed.

The transmitter 83 of the activation device 81 can in particular be suitable for transmitting to the extinguisher 3 an activation order having an energy greater than or equal to an activation energy of the extinguisher 3, for example by way of a wireless communication means, or a cable 82 such as an electrical cable or an optical fiber 82. The extinguishing device 81 is then advantageously mounted on the nacelle 1, for example in proximity to the control unit or even within the control unit, and communicates with the extinguisher 3 by a wireless communication means of WAIC or microwave type suitable for both activating the extinguisher 3 and supplying the activation energy.

The assembly may comprise a wireless receiver 84, for example mounted on the extinguisher 3, suitable for receiving the activation order transmitted by the activation device 81 by the wireless communication means, as illustrated by way of non-limiting example in FIG. 4, and for consequently activating the gas generator 34 of the extinguisher 3.

For example, the wireless receiver 84 of the extinguisher 3 may comprise a receiver of a radio signal, for example of Wi-Fi, Wireless Avionics Intra-Communications (WAIC), and/or RFID type. Alternatively or additionally, the assembly may comprise a receiver of a light wave transmitted by optical fiber 82, for example mounted on the extinguisher 3, suitable for receiving the light energy transmitted by the optical fiber 82 connecting the activation device 81 and the gas generator 34 of the extinguisher 3, and for consequently activating the gas generator 34 of the extinguisher 3. Alternatively or additionally, the activation device 81 may comprise at least one resonant circuit, for example mounted on the extinguisher 3, for example an RFID antenna or a tuned antenna, which converts the wave transmitted by the activation device 81 into a spark in the gas generator 34, thus igniting the gas generator 34.

The wireless communication means between the control unit and the activation device 81 may be further configured to determine whether or not the control unit and the activation device 81 are within communication range. For example, the control unit comprises an additional transmitter and the activation device 81 comprises an additional receiver. The additional transmitter and the additional receiver are suitable for setting up a link between them, optionally to communicate with one another, when they are located at a distance less than a previously determined distance from one another. In particular, a previously determined distance can be greater than or equal to a distance between the control unit, where applicable mounted on the pylon 500, and the activation device 81, optionally mounted on the nacelle 1, when the propulsion system 2 is mounted on the pylon 500 and in the nacelle 1. Thus, the additional transmitter and the additional receiver are suitable for setting up a link between them when the control unit is mounted on the propulsion system, optionally on the pylon 500, and when the activation device 81 is mounted on the nacelle 1, the propulsion system 2 being mounted on the pylon 500 and in the nacelle 1. Conversely, when the nacelle 1 and the propulsion system 2 are dismounted, the activation device 81 is separated from the control unit by a distance greater than the previously determined distance. The link between the additional transmitter and the additional receiver can then no longer be set up, and the wireless communication means between the control unit and the activation device 81 can then alert the user as a consequence. The wireless communication means can be configured to check, when the propulsion system 2 and the nacelle 1 are remounted at the end of the maintenance operation, that the activation device 81 and the control unit are within communication range. Thus, the wireless communication between the control unit and the activation device 81 is as reliable as a communication by cable, which makes the extinguishing operation safe.

In a first scenario, which is compatible with the first embodiment or with the second embodiment, the activation order transmitted by the activation device 81 to the extinguisher 3 may comprise a wave having an energy greater than or equal to an activation energy of the extinguisher 3. The activation energy of the extinguisher 3 is then supplied by the airplane, in particular by the power system of the airplane. The activation order transmitted by the activation device 81 is then a high-energy signal, i.e. the signal corresponding to the activation order has enough energy to directly ignite the extinguisher 3 remotely, without a local energy source 85 being necessary, as illustrated by way of non-limiting example in FIG. 6. Where applicable, the control order transmitted by the control unit may also comprise a wave having an energy greater than or equal to an activation energy of the extinguisher 3. The activation device 81 can redistribute the power of the control order to each extinguisher or to a selection of one or more extinguishers 3 separately.

In a second scenario, which is compatible with the first embodiment or with the second embodiment, the activation order transmitted by the activation device 81 to the extinguisher 3 may comprise a wave having an energy strictly less than an activation energy of the extinguisher 3. The activation order transmitted by the activation device 81 is then a low-energy signal. In the case of a wireless communication means, said wireless communication means is then of low power, so of little energy. Optionally, the control order transmitted by the control unit can also comprise a wave having an energy strictly less than an activation energy of the extinguisher 3.

In the second scenario, the activation device 81, optionally incorporated into the extinguisher 3, then comprises a local energy source 85 suitable for activating the extinguisher 3 in response to the receiving of the activation order, as illustrated by way of non-limiting example in FIG. 5. The activation order is transmitted from the transmitter 83 of the activation device 81 to the local energy source 85. Said local energy source 85 is suitable for generating, in response to the receiving of the activation order, a wave having an energy greater than or equal to the activation energy of the extinguisher 3. The local energy source 85 is suitable for transmitting this wave, i.e. for supplying the activation energy, to the extinguisher 3, and in particular to the gas generator 34 of the extinguisher 3, i.e. to provide the power needed to ignite the gas generator 34. The activation energy of the extinguisher 3 is therefore supplied by the local energy source 85.

The local energy source 85 may be located in the vicinity of or in the extinguisher 3. The local energy source 85 may be an energy recovering device. The local energy source 85 may comprise at least one of the following sources: a battery, an accumulator, a capacitor, a system for recovering vibrations of the propulsion system 2 such as a piezoelectric element generator, or a thermoelectric energy generator (TEG). The thermoelectric energy generator is suitable for generating electrical energy from the thermal gradients naturally present in the zone where the local energy source 85 is mounted. Thus, the local energy source 85 is completely independent. The presence of the local energy source 85 makes it possible to dismount and remount the nacelle 1 without having to plug in the activation device 81 again when it is mounted on the nacelle 1, or use any energy coming from the airplane.

The assembly may further comprise an energy storage device suitable for storing an energy collected by the local energy source 85. The energy storage device can be a battery, a supercapacitor, etc. The energy storage device is suitable for storing an energy greater than or equal to the activation energy of the extinguisher 3. Thus, the release of the energy by the energy storage device causes the activation of the extinguisher 3. The presence of the energy storage device, coupled with the local energy source 85, makes it possible to increase the availability of the energy.

In a first variant embodiment, which is compatible with the first or with the second embodiment and with the first or second scenario, the activation device 81 comprises the gas generator 34. Thus, the activation device 81 is carried by each extinguisher 3. The control order transmitted by the control unit is then transmitted from the control unit directly to the gas generator 34, and is suitable for consequently activating the extinguisher 3. In particular, when the control order comprises a wave having an energy greater than or equal to an activation energy of the extinguisher 3, the control order, and therefore the activation energy, can be directly transmitted from the control unit to the gas generator 34 by the transmitting elements. The energy of the control order causes the ignition of the gas generator 34, and therefore the activation of the extinguisher 3. For example, in the first embodiment, i.e. when the transmitting elements comprise an electrical cable, the wave of the control order may be an electrical current which has enough energy to ignite the gas generator 34, the control order being transmitted from the control unit directly to the gas generator 34 by the electrical cable which then connects the control unit and the gas generator 34 of the extinguisher 3.

In a second variant embodiment, which is compatible with the first or with the second embodiment and with the first or second scenario, the activation device 81 can be an activation device 81 distinct from the gas generator 34. The control order is then transmitted from the control unit to the activation device 81. The activation device 81 is suitable for activating the extinguisher 3 in response to the receiving of the control order, by the transmission to the extinguisher 3 of the activation order. The activation device 81 can be mounted on the extinguisher 3. In a variant, the activation device 81 can be mounted at a distance from the extinguisher 3 and be suitable for activating the extinguisher 3 via the wireless communication means between the activation device 81 and the extinguisher 3, the electrical cable, or the optical fiber 82 connecting the activation device 81 and the extinguisher 3, the electrical cable, or the optical fiber 82 connecting the activation device 81 and the extinguisher 3, as described above.

One or more activation devices 81 may be present, for example a single activation device 81 may be present, such that the activation device 81 forms a centralized system, for example mounted on the pylon 500 or on the nacelle 1, which distributes, in response to a control order transmitted by the control unit, one or more activation orders to one or more extinguishers 3 mounted on the nacelle 1. When several activation devices 81 are present, they can optionally be dismounted separately from one another.

In a first particular exemplary embodiment, the wireless communication means between the control unit and the activation device 81 is a laser which produces, on the order of the pilot, a light signal. The wireless communication means between the activation device 81 and the extinguisher 3 is a bundle of optical fibers 82 which connects the activation device 81 to the extinguisher 3, and more precisely to the gas generator 34 of the extinguisher 3, as shown by way of non-limiting example in FIG. 3. The optical fibers 82 receive the light signal from the laser, and use it to ignite the gas generator 34. The laser-fiber interface is provided by a lens which provides a minimum of loss at the level of the interface.

The light signal transmitted by the laser can have an energy strictly less than the activation energy of the extinguisher 3, in which case a local energy source 85 is needed to activate the extinguisher 3. The laser is then only powerful enough to transmit the control order to the activation device 81 comprising the local energy source 85, and the local energy source 85 activates the extinguisher 3 by transmitting the activation order, on receiving the control order. Thus, the laser used as communication means has an energy which remains relatively low. In a variant, the light signal transmitted by the can have an energy greater than the activation energy of the extinguisher 3, the laser being a high-power laser, in which case the light signal of the laser transmitted by the optical fiber 82 is enough to activate the extinguisher 3, in particular enough to trigger the ignition of the gas generator 34.

In a second particular exemplary embodiment, the wireless communication means between the control unit and the activation device 81 and/or the wireless communication means between the activation device 81 and the extinguisher 3 is a microwave transmitter with high power and short range, the transmitted microwave having an energy greater than the activation energy of the extinguisher 3. The nacelle 1 acts as a confined-medium waveguide and avoids external leaks, the microwaves being transmitted in the central fire zone 100, 200 or under the fan cowl 1. The activation device 81, which comprises the gas generator 34, and which can in particular be the gas generator 34, is thus capable, simply by recovering the energy transmitted by the control unit, of activating the extinguisher 3, without any local energy source 85 being needed.

The assembly may comprise several extinguishers 3, the control unit being suitable for selectively activating one or more of the extinguishers 3 of the assembly. Thus, the control unit makes it possible to centrally trigger one or more extinguishing operations, simultaneously or successively. The control unit therefore makes it possible to control the extinguishers 3 independently and separately, for example as a function of the zone and/or the extent of the fire. The control unit therefore makes it possible to sequence the extinguishing operations, to be able to perform several consecutive and independent extinguishing operations, i.e. to be able to use the extinguishing device in a desynchronized manner.

In particular, the assembly may comprise at least one pair of two extinguishers 3 configured to expel the extinguishing agent at the level of one and the same previously determined injection point, i.e. in immediate proximity to the previously determined injection point. The control unit is suitable for activating each extinguisher 3 independently of the other at each extinguishing request. Thus, the extinguishers 3 can be activated sequentially such that two injections of extinguishing agent can be made consecutively and independently from one another at the request of the pilot for each pair of extinguishers 3.

The extinguishers 3 can be configured to expel the extinguishing agent at the level of several previously determined injection points spaced apart from one another. Thus, the extinguishing of a fire can be optimized according to the location of the fire and/or extent of the fire. For example, the assembly may comprise four pairs of extinguishers 3 in one and the same fire zone 100, 200 suitable for expelling the extinguishing agent at the level of four previously determined injection points distributed in and/or around the fire zone 100, 200. More specifically, the assembly can thus comprise four pairs of extinguishers 3 in the hot fire zone 200, and/or four pairs of extinguishers 3 in the cool fire zone 100. Thus, the assembly may comprise a total of sixteen extinguishers 3. One extinguisher 3 of each pair can be activated during an extinguishing operation in a given fire zone 100, 200. The assembly for example makes it possible to perform two extinguishing operations in the cool fire zone 100 and two extinguishing operations in the hot fire zone 200.

In the second embodiment, i.e. when the transmission of the control order and/or of the activation order between the control unit and the extinguisher 3 is done by a wireless communication means, the activation device 81 can be suitable for selectively activating one or more of the extinguishers 3 of the assembly, particularly according to the control order received, for example by way of:
elements for transmitting the activation order that differ according to the extinguishers 3,
frequencies of transmission of the activation order that differ according to the extinguishers 3, and/or
identifiers that differ according to the extinguishers 3.

Thus, out of all the extinguishers 3 of the assembly, only one selection of extinguishers 3 can be activated by the transmission of the control order, then of the activation order. For example, the activation device 81 can distribute the single control order transmitted by the control unit to a selection of one or more extinguishers 3 from among the extinguishers present in the fire zone 100, 200 in question. Such a selective activation makes it possible to manage a plurality of extinguishers 3 mounted on the nacelle 1 independently.

In the case of elements for transmitting the activation order that differ according to the extinguishers 3, the control unit can be adapted to transmit a radio signal and/or a light signal and/or a structural wave. The activation device 81 is suitable for receiving the radio signal and/or the light signal and/or the structural wave transmitted by the control unit, and for consequently activating a first selection of one or more extinguishers 3 in response to the radio signal received and/or a second selection of one or more extinguishers 3 in response to the light signal received and/or a third selection of one or more extinguishers 3 in response to the structural element received. In a variant, several activation devices 81 may be present, each activation device 81 being suitable for receiving the radio signal or the light signal or the structural wave transmitted by the control unit, and for consequently activating a selection of one or more extinguishers 3 associated with the activation device 81.

In the case of frequencies of transmission of the activation order that differ according to the extinguishers 3, the activation device 81 may comprise several resonant devices, each associated with one of the selection of one or more extinguishers 3. Each resonant device is suitable for being excited by the activation order at a particular frequency range which is also different from an excitation frequency range of the other resonant devices of the activation device 81.

In the case of identifiers that differ as a function of the extinguishers 3, each activation device 81 may comprise at least one identifier, each identifier being associated with a selection of one or more extinguishers 3. The identifier can be a digital code, an RFID identifier, or another kind. The activation order contains the wave suitable for activating the selection of one or more extinguishers 3, and an item of information concerning the identifier of the selection of one or more extinguishers 3 to be activated, such that the activation device 81 selectively activates the selection of one or more extinguishers 3 matching the identifier sent by the control unit.

In the first embodiment, i.e. when the transmission of the control order and/or of the activation order between the control unit and the extinguisher 3 is done by a cable, the control unit and/or the activation device 81 can be adapted to transmit the activation order and/or the control order to only certain of the cables, in particular electrical cables linking the control unit to each of the extinguishers 3. Thus, out of all the extinguishers 3 of the assembly, only a selection of extinguishers 3 can be activated by the transmission of the control order.

The interface of the control unit with the airplane system can be unchanged, which allows total interchangeability or the replacement of an old assembly with an assembly as described above as regards the aircraft control system.

An aircraft may comprise an assembly as described below, a propulsion system 2, a wing 600, and a pylon 500 attached under the wing 600 of the aircraft. The propulsion system 2 is housed in the nacelle 1, the nacelle 1 is attached to the pylon 500. The control unit can be mounted on the pylon 500.

A method for activating an extinguisher 3 suitable for being implemented by means of an assembly as described above comprises the following steps:
transmitting a control order by the control unit to the activation device 81 of the extinguisher 3, said transmission being done by means of a wireless transmission and/or by means of a transmission by a cable connecting the control unit and the activation device 81, the method then further comprising a step of detecting an unplugged state of said cable;
receiving of the control order by the activation device 81;
transmitting an activation order by the activation device 81 to the extinguisher 3 in response to the receiving of the control order; and
expelling the extinguishing agent via the nozzle 36 in response to the activation order by the extinguisher 3.

The step of detecting the unplugged state of said cable is done before the transmitting step. The method described above has the same advantages as the assembly described above.

The control order and/or the activation order can be transmitted by:
a radio signal, for example of Wi-Fi, Wireless Avionics Intra-Communications (WAIC), and/or RFID type;
a light signal, for example of laser, Visible light communication (VLC), Li-Fi, and/or optoelectronic system type; and/or
a wave, for example of microwave type, said wave being suitable for being transmitted to the structure of the nacelle 1.

The method may further comprise a step consisting in determining, by the wireless communication means between the control unit and the activation device 81, whether or not the control unit and the activation device 81 are within communication range.

The method may comprise a step of selectively activating one or more extinguishers 3 of the assembly by the activation device 81, for example by way of:
elements for transmitting the activation order that differ as a function of the extinguishers 3,
frequencies of transmission of the activation order that differ as a function of the extinguishers 3, and/or
identifiers that differ as a function of the extinguishers 3.

The activation order transmitted by the activation device 81 to the extinguisher 3 may comprise a wave having an energy greater than or equal to an activation energy of the extinguisher 3.

The activation order transmitted by the activation device 81 to the extinguisher 3 may comprise a wave having an energy strictly less than an activation energy of the extinguisher 3, the activation of the extinguisher 3 being then done by a local energy source of the activation device 81 in response to the receiving of the activation order.

Other embodiments may be envisioned and those skilled in the art may easily modify the embodiments or exemplary embodiments described above or envision others while remaining within the scope of the invention.

1. An assembly for an aircraft propulsion system, the assembly comprising:
a nacelle extending around a longitudinal axis and configured to be disposed around the aircraft propulsion system, the nacelle comprising an internal face that delimits, with an external face of the aircraft propulsion system, a fire zone;
an extinguisher configured to extinguish a fire in the fire zone, the extinguisher comprising a tank for containing an extinguishing agent, and a spraying nozzle configured to spray the extinguishing agent out of the tank and into the fire zone;
an activation device for activating the extinguisher; and
a control unit that transmits a control order to the activation device, the activation device receiving the control order transmitted by the control unit and transmitting an activation order to the extinguisher based on the control order, the activation order activating the extinguisher so as to cause the expulsion of the extinguishing agent via the nozzle,
wherein the extinguisher is mounted on the nacelle; and
wherein the assembly includes at least one of the following elements for transmitting the control order from the control unit to the activation device:
a wireless communication means between the control unit and the activation device; or
a cable connecting the control unit and the activation device, and a system for detecting an unplugged state of the cable.

2. The assembly of claim 1, wherein the wireless communication means between the control unit and the activation device further comprises at least one of the following elements:
a means of communication by a Wi-Fi radio signal, a Wireless Avionics Intra-Communications (WAIC) radio signal, and/or an RFID radio signal;
a means of communication by a Visible light communication (VLC) signal, a Li-Fi signal, and/or an optoelectronic system light signal; or
a means of communication by a microwave configured to be transmitted to the structure of the nacelle.

3. The assembly of claim 1, wherein the element for transmitting the control order is a wireless communication means and is configured to determine whether or not the control unit and the activation device are within communication range.

4. The assembly of claim 1, wherein the extinguisher further comprises a variable volume chamber, a piston located between the tank and the variable volume chamber, and a gas generator configured to inject a propellant gas into the variable volume chamber, the injection of propellant gas causing a movement of the piston to pressurize the extinguishing agent.

5. The assembly of claim 4, wherein the element for transmitting the control order further comprises a cable, the activation device further comprises the gas generator, and the cable connects the control unit and the gas generator.

6. The assembly of claim 1, wherein the extinguisher comprises a plurality of extinguishers, and the activation device is configured to selectively activate at least one extinguisher of the plurality of extinguishers by at least one of:
elements for transmitting the activation order, the elements for transmitting the activation order differing according to the extinguishers of the plurality of extinguishers;
frequencies of transmission of the activation order, the frequencies of transmission of the activation order differing according to the extinguisher of the plurality of extinguishers; or
identifiers that differ according to the extinguisher of the plurality of extinguishers.

7. The assembly of claim 1, wherein the activation order transmitted by the activation device to the extinguisher further comprises a wave having an energy greater than or equal to an activation energy of the extinguisher.

8. The assembly of claim 1, wherein the activation order transmitted by the activation device to the extinguisher comprises a wave having an energy strictly less than an activation energy of the extinguisher, and wherein the activation device further comprises a local energy source configured to activate the extinguisher in response to the receiving of the activation order.

9. An aircraft comprising the assembly according to claim 1, the propulsion system, a wing, and a pylon attached under the wing,
wherein the nacelle is attached to the pylon.

10. A method for activating an extinguisher suitable for being implemented by the assembly according to claim 1, the method comprising:
transmitting a control order by the control unit to the activation device of the extinguisher, the transmission being done by wireless transmission and/or by a cable connecting the control unit and the activation device;
receiving the control order by the activation device;
transmitting an activation order by the activation device to the extinguisher in response to the receiving of the control order; and
expelling the extinguishing agent via the nozzle in response to the receiving of the activation order by the extinguisher.
